(19) United States
(12) Patent Application Publication
(10) Pub. No.: US 2004/0256295 A1
(43) Pub. Date: Dec. 23, 2004

(54) Method and device for the flotation of contaminants from an aqueous fibrous suspension

(75) Inventors: Herbert Britz, Weingarten (DE); Axel Dreyer, Ravensburg (DE); Harald Hess, Grunkraut (DE); Martin Kemper, Weingarten (DE); Dietrich Moller, Ebersbach (DE); Anton Selbherr, Radolfzell (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/869,876

(22) Filed: Jun. 18, 2004

(30) Foreign Application Priority Data
Jun. 20, 2003 (DE) 103 27 701.3

(51) Int. Cl. B03D 1/24; B03D 1/00; B03D 1/14

(52) U.S. Cl. 209/170; 209/162

(57) ABSTRACT

Method and flotation vessel for removing contaminants from aqueous fibrous suspension. The method includes damming up fibrous suspension at a head level above a bottom of flotation vessel, and forming a bubble flow via gas bubbles rising counter to gravity in dammed fibrous suspension, such that fibrous suspension is carried counter to ascending direction of bubble flow and contaminants are deposited on gas bubbles. Accepts, discharged in cleaned form, are carried counter to bubble flow, and contaminants and bubbles are discharged in thickened flotation foam. A flow cross-section of flotation vessel transverse to bubble flow is formed straight on at least 80% of at least one side wall, and length of side wall is at least 1.5 times greater than width of end wall. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of German Patent Application No. 103 27 701.3 filed Jun. 20, 2003, the disclosure of which is expressly incorporated by reference herein in its entirety.

### BACKGROUND OF THE INVENTION

1. Field of the Invention

The present invention relates to a method for the flotation of contaminants from an aqueous fibrous suspension in an upright flotation vessel in which the fibrous suspension is dammed up at a head level above the bottom of the flotation vessel, and a bubble flow, rising counter to the field of gravity in the dammed fibrous suspension, is formed with the aid of gas bubbles. The fibrous suspension is carried counter to the ascending direction of the bubble flow and discharged in cleaned form as accepts, and the contaminants are deposited on the gas bubbles and discharged together with the gas bubbles in a thickened flotation foam.

2. Discussion of Background Information

Methods of the type mentioned are used in order to separate out from an aqueous fibrous suspension at least a portion of the contaminant particles suspended therein. As is known, in a flotation process, a foam or floating sludge is formed containing the substances to be separated out. A typical application of such a method is the treatment of an aqueous fibrous suspension obtained from printed recovered paper in which the printing ink particles are already released from fibers so that they may be floated off. The flotation process described here utilizes the differences between pulp and undesirable solid particles in that the pulp remains in the fibrous suspension on account of its hydrophilic nature, while the targeted solid particles are hydrophobic and hence move into the foam together with the air bubbles. In addition to printing ink particles, there is also a multitude of other substances that are hydrophobic and thus can be separated from the pulp through flotation. Such substances are, in particular, adhesives, fine plastic particles, and sometimes also resins. When fibers are to be separated from contaminants through the flotation process, but not all solid particles are to be removed, it is called “selective flotation.” The term “flotation de-inking”, which is also used, is normally used not only for the removal of printing ink particles (ink=printing ink), but also more generally for the selective flotation of contaminants out of fibrous suspensions.

The prior art with regard to flotation methods for fibrous suspensions is already very advanced. Therefore, there are solutions that are entirely appropriate for removing a large part of the solid particles through flotation. Since flotation systems are relatively expensive to purchase and operate, it is an understandable goal to improve their effectiveness or to reduce the expense necessary for achieving the same results.

In the course of ongoing development of methods and apparatuses for the flotation of fibrous suspensions, particularly the movement of suspension and air bubbles in the flotation vessel, has been varied. An important flow principle in this context is the counter-current movement, i.e., the fibrous suspension carried hydraulically essentially against the direction of flow of the air bubbles rising counter to the field of gravity. In the most common case by far, in which the driving force of the flotation is the earth's gravitation, this thus means that the air bubbles rise upward, and the fibrous suspension is carried downward. This means that the “dirtiest” suspension comes into contact with the already heavily loaded air bubbles and becomes increasingly cleaner on the way downward, where the air bubbles then encountered also carry less dirt. With this counter-current principle, it is important that the speeds are optimally coordinated with one another in order to obtain the best flotation effect possible.

A simple example of counter-current flotation is shown in FIG. 4 of the technical paper “Neue Systembausteine zur Aufbereitung von Altpapier: Entwicklung und Betriebserfahrungen,” J. Kleuser and T. H. Egenes, Wochenblatt für Papierfabrikation, 14/15, 1996. There, the stock feed takes place in the upper third of a round flotation apparatus, while gassing takes place in the lower part directly above the accepts discharge lying below. The foam is collected in the uppermost part of the flotation column and carried off. Another possibility is known, for example, from DE 198 23 053. There the addition of the fibrous suspension occurs in the already formed foam. Here, too, air bubbles and suspension are moved in counter-current.

Methods of this nature are already widely used in industry, i.e., in the stock preparation required for papermaking, plants are operated that use this method and must process huge production quantities. The expected, and today also possible, optimal effect of such processes depends critically on the flow speeds that arise in the flotation vessels used. As a result, vessel volumes, cross-sections, piping, etc. must be matched to the desired production quantity in new facilities. When this matching succeeds without technological disadvantages, the effect is indeed assured, but higher costs arise due to constant new designs and changes in the fabrication of such devices.

### SUMMARY OF THE INVENTION

The present invention further improves flotation processes of this nature. In this manner, it should be possible to optimize the cleaning result and/or yield of the process as easily as possible, even for differing production quantities.

According to the invention, the flow cross-section of the flotation vessel located transverse to the bubble flow is straight on at least 80% of at least one side wall, and the length of the side wall is at least 1.5 times, preferably at least 2 times, as great as the width of the end wall.

Through the features described, it is possible to produce an even flow in the flotation vessel, since disruptive turbulences are largely avoided due to the length/width ratio chosen, and hence the counterflow of suspension and bubble flow can develop in optimal fashion. Moreover, the additional advantage is afforded that the entire flotation system is easily built from modules, i.e., individual flotation vessels. These modules are easily installed together at their side walls. In this embodiment of the method, the modules with which a flotation step (e.g., primary or secondary flotation) is to be performed are operated in parallel. For greater throughputs in one stage, correspondingly more modules are used, and for smaller throughputs, correspondingly fewer. New, expensive optimization attempts are then no longer necessary.

The method in accordance with the invention can be applied to all forms described in the preamble. In this context, the fibrous suspensions for flotation can be, e.g., added directly to the liquid found in the flotation vessel, or above this to the foam area, which is to say in accordance with the aforementioned DE 198 23 053. Since the fibrous suspension is added to the rising foam in methods of the last-mentioned type, it encounters an already formed air bubble composite with fluid channels located therebetween. In this way, the countercurrent principle is realized especially favorably.

The present invention is directed to a method for removing contaminants from an aqueous fibrous suspension using an upright flotation vessel. The method includes damming up the fibrous suspension at a head level above a bottom of the flotation vessel, and forming a bubble flow with the aid of gas bubbles that rises counter to the field of gravity in the dammed fibrous suspension, such that the fibrous suspension is carried counter to an ascending direction of the bubble flow and contaminants are deposited on the gas bubbles. The method also includes discharging in cleaned form as accepts the fibrous suspension carried counter to the bubble flow, and discharging the contaminants and the gas bubbles in a thickened flotation foam. A flow cross-section of the flotation vessel located transverse to the bubble flow is formed to be straight on at least 80% of at least one side wall, and a length of the side wall is at least 1.5 times greater than a width of an end wall.

In accordance with a feature of the invention, the length of the side wall may be at least 2 times greater than the width of the end wall. Further, the length can be at least 3 times greater than the width.

According to another feature of the invention, the flow cross-section is essentially rectangular.

According to still another feature of the present invention, a hydraulic diameter of the flow cross-section may be no greater than 2.7 m.

Further, the method can include feeding the fibrous suspension into the flotation vessel above a bottom half of the head level.

The method can also include feeding the fibrous suspension into the flotation vessel to be uniformly distributed over at least 80% of the flow cross-section.

In accordance with still another feature of the instant invention, at least two flotation vessels of equal size can be used, and the at least two flotation vessels can be arranged to touch one another on their side walls. The at least two flotation vessels can be connected in parallel. Further, the flotation vessels may be open in design on the adjoining side walls.

Moreover, the method can be utilized in a flotation system composed of flotation vessels of equal size. The side walls of the flotation vessels may be arranged to contact each other, and the flotation vessels can be open in design on their adjoining side walls.

According to another feature of the present invention, the process can include directly adding the fibrous suspension for flotation into the rising flotation foam.

In accordance with a further feature of the present invention, the fibrous suspension added for flotation may be unaerated, and the method can further include aerating the added fibrous suspension beneath the addition point.

According to a still further feature of the invention, the fibrous suspension added for flotation may be aerated, and the method can further include partially aerating the fibrous suspension beneath the addition point.

The method may also include adjusting a height at which the suspension is introduced into the flotation vessel.

Further, the method can include adjusting a quantity of added air.

According to still another feature of the instant invention, the process can include returning a branch flow of the flotation foam to a feed of the flotation vessel. The process can also include regulating the branch flow.

The present invention is directed to a flotation vessel for removing contaminants from an aqueous fibrous suspension. The flotation vessel includes a flow cross-section oriented transversely to a direction of gravity that is formed to be straight on at least 80% of at least one side wall, and a length of the at least one side wall is at least 1.5 times greater than a width of an end wall.

In accordance with a feature of the instant invention, a fibrous suspension feed can be located above a bottom half of the head level. The feed can be structured and arranged to uniformly distribute the fibrous suspension over at least 80% of the flow cross-section.

According to another feature of the invention, an aeration device can be structured and arranged to aerate the fibrous suspension at a location beneath the addition point. Further, the fibrous suspension added through the feed can be unaerated. Still further, the fibrous suspension added through the feed may be aerated.

According to the invention, the flotation vessel can also include a feed for introducing the suspension, in which a height of the feed is adjustable.

Moreover, the flotation vessel may also include a device for adjusting a quantity of added air.

In accordance with still yet another feature of the present invention, a branch flow can be provided to return at least a part of the flotation foam to a feed of the flotation vessel. The return branch can include a regulating device.

The invention is directed to a flotation system including at least two of the above-described flotation vessels. The at least two flotation vessels are of equal size, and are arranged to touch one another on their side walls. The at least two flotation vessels can be connected in parallel. Further, the at least two flotation vessels may be open in design on the adjoining side walls.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates an exemplary embodiment of the instant method;

FIG. 2 illustrates a view of a flotation system in accordance with the method;

FIG. 3 illustrates an example connection of two module groups;

FIG. 4 illustrates a variant of the method;

FIG. 5 illustrates an implementation of the method with foam recirculation.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

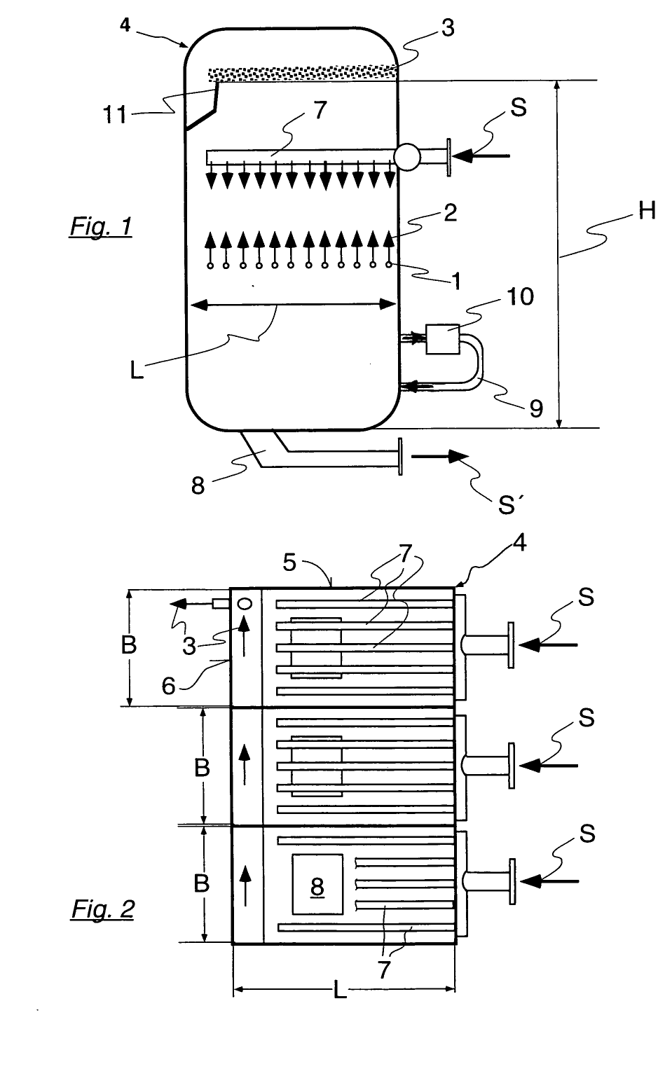

The flotation vessel 4 shown in FIG. 1 is shown in a sectional side view. Fibrous suspension S is added through distribution pipes 7, here located relatively far upward, to the fibrous suspension already located in flotation vessel 4. Gas bubbles 1, of which only a few are drawn, form a bubble flow 2. Added fibrous suspension S is carried counter to the ascending direction of bubble flow 2 and through this, and in cleaned form as accepts S′ piped through accepts outlet 8 out of flotation vessel 4. During this process, the flow cross-section remains essentially the same. The contained contaminants are deposited on gas bubbles 1 in a manner known per se, and discharged upward in a thickened flotation foam 3, which has a volumetric gas content of at least 74%. The foam is dammed up in flotation vessel 4 at a foam gutter 11, which in general has an adjustable spillover weir. The suspension in flotation vessel 4 beneath flotation foam 3 has a head level H. In the example shown here, gassing of the suspension is accomplished by a gassing circuit 9 whose function includes drawing off a portion of the fibrous suspension, mixing it with gas in a gassing element 10, and then pumping it back into flotation vessel 4 at a somewhat lower point (it could also be a higher point). As shown in FIG. 2, which depicts in diagrammatic form a total of three flotation vessels 4 in section and in a view from above, are side wall 5 with length L and end wall 6 with width B. The ratio of length to width is significant to the practice of the method, and should be at least 1.5. Especially good flotation results can be achieved with a ratio of more than at least 3. The plurality of distribution pipes 7 serves to distribute incoming fibrous suspension S evenly across the flow cross-section. They are preferably equipped with holes, but can also be replaced by other distribution systems.

As is known, the hydraulic diameter for a given flow cross-section area can be varied by varying the length to width ratio. The hydraulic diameter is calculated according the formula: four times the cross-section area divided by the wetted circumference. It is greatest with circular cross-sections and can be reduced significantly by the measures described in the claims. This calms the suspension flow in the flotation vessel and improves the effectiveness of the method. Using the example of a flow cross-section area of 4 m², with a—hitherto customary—circular cross-section the hydraulic cross-section is approximately 2.3 m. If, in contrast, a rectangle with L=4 m and B=1 m is chosen, it is 1.6 m. If, for economic reasons, a larger flow cross-section area of 8 m² is chosen, the hydraulic diameter is 3.19 m for a circle and only 2.67 m for a rectangle with L=4 m and B=2 m.

In many cases a further advantage can be realized, since in addition to substantially improving the hydraulic conditions in flotation vessel 4, the embodiment of the flow cross-section also produces a simple possibility for the modular construction of the entire flotation system. As a result of the completely, or at least—largely, straight side border of the flotation cell, modules can be installed next to one another in that they adjoin at the side walls. The problems of bulging that sometimes occur in angular containers then do not occur at the contact surfaces. It is not absolutely necessary for the walls to be solid between the modules; they can also have openings, e.g., in the bottom area of the flotation vessel 4. They may also be missing altogether if a uniform flow arises in the modules without them.

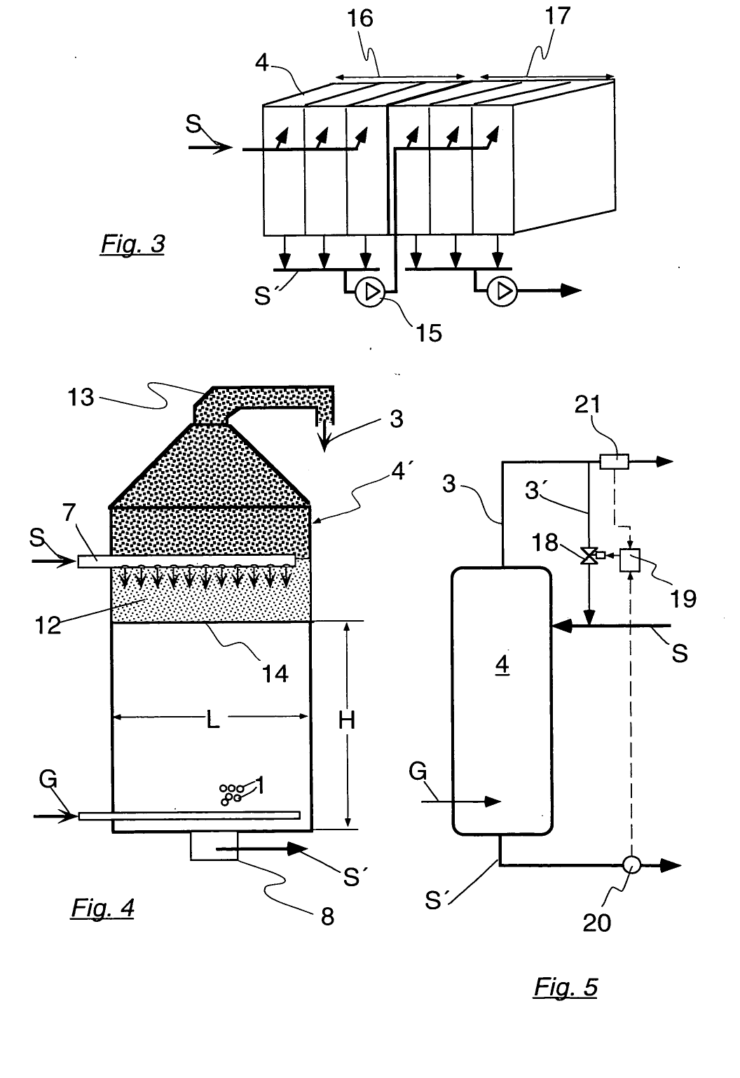

One possible mixture of parallel and series connections is shown in schematic form in FIG. 3. In accordance with this example, three modules of flotation vessels respectively are operated in parallel, which is to say that in the first group 16, three flotation cells are supplied with the same fibrous suspension S. The accepts S′ from these three modules formed through flotation are combined and fed to second group 17 of again three modules by a pump 15. Pump 15 can also be used here for renewed gassing of accepts S′. The advantages of the invention also apply to such systems. The method shown in FIG. 3 is to be understood merely as an example here. It would also be possible to use a single system composed of modules in two-stage operation in which the reject (foam) of the first stage is conveyed into the feed of the second stage.

As already mentioned and shown in FIG. 4, it is also possible to add fibrous suspension S directly to rising foam 12. In this way, foam 12 located directly beneath distribution pipes 7 is very strongly infiltrated with suspension, which leads to a change in the foam bubbles. Because of the delivery of liquid, the gas bubbles in this region are spherical. Above distribution pipes 7, the gas content is greater than 74%, and the foam bubbles have a polyhedral shape. Beneath foam 12, an interface 14 forms at which head level H is defined. Below interface 14, the gas content is less than 50%. Instead of an interface, a transition zone may also form. In the example shown here, gas G required for formation of the gas bubbles 1 is blown directly into the suspension. Of course, this method is also possible with the other flotation arrangements shown. Thickened foam 3 is forced upward out of flotation vessel 4′ via a surge pipe 13 due to an overpressure that is present.

In many cases, the method is carried out such that only a single pass through a flotation vessel occurs in a stage. Then multiple flotation vessels of a flotation stage are not connected in series, but rather in parallel, so that flotation foam 3 produced has virtually the same quality throughout. A branch flow 3′ of this foam can advantageously be recirculated in the feed to flotation vessel 4, which is shown schematically in FIG. 5 (side view). In this process, the non-recirculated flotation foam thickens, which considerably simplifies reject treatment and disposal. The size of the recirculated branch flow 3′ can be adjusted for optimizing the process such that the loss of stock is minimal with the required quality. To this end, the signal (e.g., the degree of brightness) from a quality sensor 20 in outflowing accepts S′ is transmitted to a controller 19, which modifies branch flow 3′ via a control valve 18. An alternative to this is regulating the foam quantity with the aid of a flowmeter 21, combined with measurement of the foam consistency, in which control valve 18 is activated in turn.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made within the purview of the appended claims, as presently stated and as amended, without departing from the scope and spirit of the present invention in its aspects. Although the present invention has been described here in with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for removing contaminants from an aqueous fibrous suspension using an upright flotation vessel, comprising:
damming up the fibrous suspension at a head level above a bottom of the flotation vessel;
forming a bubble flow with the aid of gas bubbles that rises counter to the field of gravity in the dammed fibrous suspension, such that the fibrous suspension is carried counter to an ascending direction of the bubble flow and contaminants are deposited on the gas bubbles;
discharging in cleaned form as accepts the fibrous suspension carried counter to the bubble flow;
discharging the contaminants and the gas bubbles in a thickened flotation foam, wherein a flow cross-section of the flotation vessel located transverse to the bubble flow is formed to be straight on at least 80% of at least one side wall, and a length of the side wall is at least 1.5 times greater than a width of an end wall.

2. The method in accordance with claim 1, wherein the length of the side wall is at least 2 times greater than the width of the end wall.

3. The method in accordance with claim 2, wherein the length is at least 3 times greater than the width.

4. The method in accordance with claim 1, wherein the flow cross-section is essentially rectangular.

5. The method in accordance with claim 1, wherein an hydraulic diameter of the flow cross-section is no greater than 2.7 m.

6. The method in accordance with claim 1, further comprising feeding the fibrous suspension into the flotation vessel above a bottom half of the head level.

7. The method in accordance with claim 1, further comprising feeding the fibrous suspension into the flotation vessel to be uniformly distributed over at least 80% of the flow cross-section.

8. The method in accordance with claim 1, wherein at least two flotation vessels of equal size are used, and the at least two flotation vessels are arranged to touch one another on their side walls.

9. The method in accordance with claim 8, wherein the at least two flotation vessels are connected in parallel.

10. The method in accordance with claim 8, wherein the flotation vessels are open in design on the adjoining side walls.

11. The method in accordance with claim 1, wherein said method is utilized in a flotation system composed of flotation vessels of equal size.

12. The method in accordance with claim 11, wherein the side walls of the flotation vessels are arranged to contact each other, and the flotation vessels are open in design on their adjoining side walls.

13. The method in accordance with claim 1, further comprising directly adding the fibrous suspension for flotation into the rising flotation foam.

14. The method in accordance with claim 1, wherein the fibrous suspension added for flotation is unaerated, and the method further comprises aerating the added fibrous suspension beneath the addition point.

15. The method in accordance with claim 1, wherein the fibrous suspension added for flotation is aerated, and the method further comprises partially aerating the fibrous suspension beneath the addition point.

16. The method in accordance with claim 1, further comprising adjusting a height at which the suspension is introduced into the flotation vessel.

17. The method in accordance with claim 1, further comprising adjusting a quantity of added air.

18. The method in accordance with claim 1, further comprising returning a branch flow of the flotation foam to a feed of the flotation vessel.

19. The method in accordance with claim 18, further comprising regulating the branch flow.

20. A flotation vessel for removing contaminants from an aqueous fibrous suspension, comprising:
a flow cross-section oriented transversely to a direction of gravity that is formed to be straight on at least 80% of at least one side wall; and
a length of said at least one side wall is at least 1.5 times greater than a width of an end wall.

21. The flotation vessel in accordance with claim 20, wherein said length of the side wall is at least 2 times greater than the width of said end wall.

22. The flotation vessel in accordance with claim 21, wherein said length is at least 3 times greater than said width.

23. The flotation vessel in accordance with claim 20, wherein said flow cross-section is essentially rectangular.

24. The flotation vessel in accordance with claim 20, wherein a hydraulic diameter of said flow cross-section is no greater than 2.7 m.

25. The flotation vessel in accordance with claim 20, further comprising a fibrous suspension feed located above a bottom half of the head level.

26. The flotation vessel in accordance with claim 25, wherein the feed is structured and arranged to uniformly distribute the fibrous suspension over at least 80% of said the flow cross-section.

27. The flotation vessel in accordance with claim 20, further comprising an aeration device structured and arranged to aerate the fibrous suspension at a location beneath the addition point.

28. The flotation vessel in accordance with claim 27, wherein the fibrous suspension added through the feed is unaerated.

29. The flotation vessel in accordance with claim 27, wherein the fibrous suspension added through the feed is aerated.

30. The flotation vessel in accordance with claim 20, further comprising a feed for introducing the suspension, wherein a height of said feed is adjustable.

31. The flotation vessel in accordance with claim 20, further comprising a device for adjusting a quantity of added air.

32. The flotation vessel in accordance with claim 20, further comprising a branch flow to return at least a part of the flotation foam to a feed of the flotation vessel.

33. The flotation vessel in accordance with claim 32, wherein said return branch is comprises a regulating device.

34. A flotation system comprising at least two flotation vessels in accordance with claim 20, wherein said at least two flotation vessels are of equal size, and are arranged to touch one another on their side walls.

35. The flotation system in accordance with claim 34, wherein said at least two flotation vessels are connected in parallel.

36. The flotation vessel in accordance with claim 34, wherein said at least two flotation vessels are open in design on the adjoining side walls.
